(19) United States
(12) Patent Application Publication
(10) Pub. No.: US 2011/0239762 A1
(43) Pub. Date: Oct. 6, 2011

(54) Method for Determining the Speed of a Vehicle During a Braking Application

(76) Inventors: Wolfgang Rulka, Munchen (DE); Thorsten Stützle, Nurnberg (DE); Uwe Viereck, Berlin (DE)

(21) Appl. No.: 13/133,672

(22) PCT Filed: Nov. 19, 2009
(86) PCT No.: PCT/EP2009/065449

§ 371 Date: Jun. 9, 2011

(30) Foreign Application Priority Data
Dec. 10, 2008 (DE) 10 2008 061 456.4

(51) Int. Cl. G01P 3/00

(52) U.S. Cl. 73/497

(57) ABSTRACT

A method of determining a speed of a vehicle during braking is provided. A pressure p in a braking device is determined in accordance with the ideal gas equation p·V=n·R·T. V is the volume V of the brake cylinder, n is the mole number n of the gas in the brake cylinder, R is the gas constant R and T is the temperature T. The brake force F is determined from the pressure p in the brake cylinder and from the impacted piston area A of the brake cylinder in accordance with

$$p = \frac{F}{A} ,$$

and the instantaneous speed v of the vehicle is determined from a known initial speed v_{A} and from the acceleration a which is determined from the brake force F and the vehicle mass M in accordance with F=M·a.

### CROSS REFERENCE TO RELATED APPLICATIONS

This application is the US National Stage of International Application No. PCT/EP2009/065449 filed November 19, 2009, and claims the benefit thereof. The International Application claims the benefits of German Application No. 10 2008 061 456.4 DE filed Dec. 10, 2008. All of the applications are incorporated by reference herein in their entirety.

### FIELD OF INVENTION

The invention relates to a method for determining the speed v of a vehicle during a braking application, the brake force F being determined by means of the pressure p in a braking device, and the speed v of the vehicle being determined by means of the brake force F.

### BACKGROUND OF INVENTION

In order to be able to stop a vehicle, in particular a rail vehicle, quickly and reliably, it is necessary to know the instantaneous speed during the braking application. Customary methods for determining the speed, in the case of which a sensor is used to measure the rotational speed of a wheel, fail when a blocked wheel slips on the rail.

It is proposed to estimate the speed in DE 40 24 815 A1. Here, the first step is to determine the brake force from the pressure in the braking device, and then to determine the speed of the vehicle by means of the brake force. A pressure sensor is required to determine the pressure in the braking device. An alternatively possible estimate of the pressure does not ensure adequate accuracy.

### SUMMARY OF INVENTION

It is an object of the invention to specify a method for determining the speed v of a vehicle during a braking application, wherein a pressure p, that is required to determine the speed v, is determined reliably.

The object is achieved by virtue of the fact that the pressure p in the braking device is determined as the pressure p in a brake cylinder of the braking device in accordance with the ideal gas equation p·V=n·R·T. V is the volume V of the brake cylinder, n is the mole number n of the gas in the brake cylinder, R is the gas constant R and T is the temperature T. The mole number n is determined from the gas mass m in the brake cylinder, and the gas mass m is determined from the gas mass flow \dot{m} flowing to the brake cylinder. The gas mass flow \dot{m} depends on the control pressure p_{D} produced in the braking device, on the external air pressure p_{A}, the temperature T and on system parameters which describe the braking device. The brake force F is determined from the pressure p in the brake cylinder and from the impacted piston area A of the brake cylinder

$$p = \frac{F}{A} ,$$

in accordance with and the instantaneous speed v of the vehicle is determined from a known initial speed v_{A} and from the acceleration a which is determined from the brake force F and the vehicle mass M in accordance with F=M·a.

The method yields the advantage that there is available for the first time a reliable model for determining the pressure in the braking device so that this pressure can be used in order to be able to calculate the respective actual speed by means of known vehicle laws during a braking application of a vehicle. The actual pressure in the brake cylinder need not be known until the braking device is actuated.

The particular advantage attained with the method is that the actual instantaneous speed of a rail vehicle can always be determined without a complicated additional sensor system irrespective of whether the wheels of said rail vehicle are rotating or whether the wheels are sliding. The braking of the rail vehicle can be performed safely and reliably by virtue of the fact that the speed is always very accurately known.

1. (canceled)

2. A method of determining a speed v of a vehicle during a braking application, comprising:
determining a pressure p in a brake cylinder of the braking device in accordance with the ideal gas equation p·V=n·R·T, wherein
V is a volume V of the brake cylinder,
n is a mole number n of the gas in the brake cylinder,
R is a gas constant R, and
T is a temperature T,
wherein the mole number n is determined from a gas mass m in the brake cylinder, and the gas mass m is determined from a gas mass flow \dot{m} flowing to the brake cylinder, said gas mass flow m depending on
a control pressure p_{D} produced in the braking device,
an external air pressure p_{A},
the temperature T and on system parameters which describe the braking device;
determining a brake force F based upon the pressure p in the brake cylinder and an impacted piston area A of the brake cylinder in accordance with
$$p = \frac{F}{A} ;$$
and
determining an instantaneous speed v of the vehicle based upon a known initial speed v_{A} and an acceleration a, wherein the acceleration a is determined from the brake force F and the vehicle mass M in accordance with F=M·a.
